(19) United States
(12) Patent Application Publication
(10) Pub. No.: US 2010/0250179 A1
(43) Pub. Date: Sep. 30, 2010

(54) METHOD AND APPARATUS FOR MEASURING AND ESTIMATING SUBJECT MOTION IN VARIABLE SIGNAL RECEPTION ENVIRONMENTS

(76) Inventors: Thomas Mariano, Londonderry, NH (US); Marilyn Mariano, Londonderry, NH (US)

Correspondence Address: Daniels Patent Law PLLC, 43 Centre Street, Concord, NH, 03301, US

(21) Appl. No.: 12/413,049

(22) Filed: Mar. 27, 2009

(51) Int. Cl. G01P 21/00; G01P 15/00; G01P 7/00; G01B 21/16

(52) U.S. Cl. 702/96; 702/141; 702/142; 702/158

(57) ABSTRACT

A dynamic motion and distance measuring device for estimating and measuring speed and distance covered by a subject engaged in an athletic endeavor and more particularly to measuring and estimating the speed and distance and providing a relative indication of a measured speed and distance to an optimal speed and distance and/or time including finish time of the subject engaged in an athletic event, even where the event is occurring in changing environment or terrain conditions where remote data collection and signal reception is inconsistent and variable.

### FIELD OF THE INVENTION

The present embodiments of a dynamic motion and distance measuring device relate to a method and apparatus for estimating and measuring speed and distance covered by a subject engaged in an athletic endeavor and more particularly to measuring and estimating the speed and distance and providing a relative indication of a measured speed and distance to an optimal speed and distance and/or time including finish time of the subject engaged in an athletic event, even where the event is occurring in changing environment or terrain conditions where remote data collection and signal reception is inconsistent and variable.

### BACKGROUND OF THE INVENTION

Although the following discussion of the background will focus on the use of the below described speed and distance measuring devices in equestrian events, it is to be appreciated that the use and applications of the presently described speed and distance measurement device extends beyond equestrian athletic events. The embodiments of the present invention may also encompass other athletic endeavors including, but not limited to hiking, cross-country running, biking, mountaineering and orienteering to name a few. In this regard the description herein, although directed to an exemplary use of the underlying technology with equestrian events is not limiting but intended for use in any endeavor, training or competition or otherwise where speed and distance measurement are critical factors.

In the field of athletic distance and location measurement it has been known for a long time to use a basic pedometer to measure the distance and velocity of an athlete, or an animal involved in an athletic event such as a horse and rider. For purposes of the present description it is to be understood that a horse, and a horse and rider in equestrian events are referred to singularly as an athlete. Such pedometers are convenient in that they can be sized so that they can be easily worn by a user during such athletic events. The pedometer senses the vertical motion of the athlete corresponding to the steps or strides of the athlete however the accuracy of such known pedometer devices is less than desirable.

Measurements with a pedometer are generally based upon a predetermined stride length and gait of the athlete, or animal, and determine distance traveled by the athlete according to stride counting. Such portable pedometers have failed to gain widespread acceptance mainly because the results obtained therefrom are typically inaccurate. The inaccuracy results from the fact that the athlete's or animals stride must be consistent in order to return an accurate distance and speed. Obviously and by way of example in cross-country running or equestrian cross-country terrain is often extremely varied and a consistent stride cannot be maintained. Also, an athlete's stride may change according to their health and fitness over time as well as the particular duration of the athletic event so that it is very difficult to attain a truly consistent stride for purposes of accurate speed and distance measurement. In these cases the distance can only be roughly estimated by multiplying the number of steps taken by the step size, i.e. stride, and/or dividing by time to attain an estimate of speed. Where the actual stride is different from the theoretical stride the inaccuracies accumulate due to such stride variation and therefore such devices return less than adequate results of distance and speed measurements.

To compensate for the disadvantages of the prior art pedometers, electronic distance measuring devices have been configured to include both the pedometer and an accelerometer. An accelerometer senses an acceleration force of the athlete resulting from the athlete's impact with the ground while walking, running, hiking, etc. The acceleration force may be detected by numerous methods, including detection of a change in the electrical resistance of a flexure or measurement of displacement of a silicon mass. The acceleration force of the user is translated into a step size of the user, which is then used to determine the distance traveled.

Although accelerometers provide a mechanism for determining the user step size, accelerometer measurements are not always accurate or consistent. The accelerometers may still sense other movement of the user not associated with actual traveled steps, such as if the user significantly changes activities or actively rests during the athletic event. Additionally, the accelerometer provides no initial calibration of the pedometer, but still requires the user to initially calibrate the pedometer so as to have a general zeroing, or base value for the user step size.

Even with the disadvantages of both pedometers and accelerometers, both have been used in location determining systems commonly with a global positioning system, “GPS” receiver to determine or calculate location and position of the user. However, the GPS receiver is not always operable when GPS satellite signals are blocked by heavily wooded areas, building structures, terrain impediments such as cliffs or mountains, etc. Such location determining systems compensate for the accessibility of GPS satellite systems by providing the pedometer and/or accelerometer measurements, which are operable to determine the distance traveled from a previously known location.

These known devices are still particularly dependent on determining the step size of the user and counting steps as in U.S. Pat. No. 7,245,254 to Vogt. This reference describes an electronic location determining device having a GPS receiver and including a pedometer and an accelerometer for determining the number of steps and step size to obtain distance traveled of the user if the GPS signal is not available. Vogt '254 describes a continuous step size calibration process to determine a distance traveled based on both the pedometer and accelerometer data for use when the GPS signal is not available. The last known step size of the user is used while there is no GPS signal. As discussed above the pedometer and/or accelerometer is not consistently accurate, causing error to accumulate in the acquired data of the pedometer and/or accelerometer without the location determining data components of the location determining system. Here, there is no use of GPS data in combination with the pedometer/accelerometer data to improve the distance measurement. Vogt '254 describes the conventional use of a GPS receiver in the device merely for receiving GPS satellite signals when accessible and providing a location and/or distance traveled between two points. Also, when the GPS signal is restored, the new GPS location is used overriding the estimate from the pedometer/accelerometer during GPS loss. This assumes that the user traveled in a straight line while the GPS signal was not present and this assumption will not always be accurate. GPS systems alone are not accurate enough for some applications. GPS systems typically have an accuracy of plus or minus 10 meters and do not lend themselves to calculation of instantaneous speed because each position reading by the system has error of +/−10 meters the distance calculation between two points has therefore a possible error of +/−20 meters. Successive calculations solely by the GPS may build and compound these errors in any calculation of speed.

The present invention was developed based upon the need for a more accurate speed and distance measurement device for training and competing in the cross-country portion of an equestrian sport known formally as Eventing. Eventing is a sport in which horses and riders participate in three distinct trials for a combined score to determine the winner. It is an international Olympic sport which includes dressage, stadium jumping and a cross-country event. The cross-country event consists of a measured course through fields, woods and natural country side with jumps and obstacles such as water crossings, ditches, drops, banks, etc. The course has a set length and optimal time at which it should be completed.

Currently, many competitors use a simple count-down timer watch that was developed for this market. The optimal time is programmed into the watch, and a countdown of the time is begun by the rider pressing “start” when they leave the start box. The watch, like any countdown timer, gives the rider only an idea of how much time they have left to complete the course. However there is no way of knowing how far along in the course they are i.e. their relative course position, compared to where they should be, i.e. their desired course position, to complete the course within, or as close to the optimum time as possible. By the time a rider comes within sight of the finish line they could be too far behind to catch up, or are too fast, and cannot according to the rules stop, or slow down to avoid time penalties. It would of course be quite helpful to a rider in a competition to know earlier in the course if they are on the appropriate speed or pace to meet the optimal time. The present invention is also an excellent training aid since both experienced and novice riders can always use feedback as to their pace or speed at which they are navigating the course in order to gain a better feel for a specific pace or speed.

Prior art location determining systems comprising the GPS receiver and the pedometer and/or accelerometer are not configured to calculate the distance traveled rather, they are configured to determine the location or position of the user. As such, the systems provide no method or mechanism for calibrating the pedometer and combining this calibration with the GPS calculations so that the measurement system as a whole does not calculate a more accurate distance traveled better than the GPS can do alone. Instead the systems merely correct accumulated position error once GPS satellite signals are accessible which does not update and allow the pedometer to accurately determine the distance traveled and future times when GPS signals are again inaccessible.

Accordingly, there is a need for improved distance measuring device that overcomes the limitations of the prior art. More particularly there is a need for a device that will accurately determine a distance traveled, even when the location determining component of the devices are not accessible and also by using other methods in combination with the location determining device to improve accuracy. Additionally, the need for a device that does not require initial calibration of the user step size or speed. Further, there is a need for a device that upon restoration of the accessibility of the location determining component is able to determine an accurate distance traveled without assuming a straight line path while the location determining component was inaccessible.

Consequently, a need exists for a method and apparatus relating to an improved speed and distance measuring device that overcomes the known limitations of the prior art, particularly where the location determining component of the GPS satellite system is inaccessible.

### OBJECT AND SUMMARY OF THE INVENTION

It is an object of the present invention to provide a light weight, easily viewable speed and distance measurement device for athletes.

It is another object of the present invention to provide the speed and distance measurement device with a GPS system which interfaces with the device to provide accurate location data for performing calculations to attain highly accurate speed and distance measurements.

It is yet another object of the present invention to ensure that the speed and distance measurement device is capable of being used in equestrian events as worn by the rider of a horse during an eventing competition or training, where the speed and timing of the horse and rider along the course is a critical component of the competition.

A still further object of the present invention is to provide an easily viewable or audible signal which indicates whether the user's current condition and location are within a desired range of predefined parameters.

The present invention relates to a speed and distance measuring device for an athlete in one of a competitive and training athletic event, the speed and distance measuring device comprising a digital data storage means, a user input for saving at least an event-based parameter in the digital data storage means, an accelerometer for determining an acceleration profile of the athlete for determining a first speed and distance estimate for the athlete during the competitive or training event, a global positioning system receiver for determining a second speed and distance estimate, and wherein a combination of the first and second speed and distance estimates determines a real-time speed and distance of the athlete for comparison with the event-based parameter.

In equestrian athletic events such as the Eventing discipline of cross-country, the time at which the rider completes the course becomes a critical factor in the competition. An optimal time is determined by a race committee prior to the event. The time is based specifically on the length and difficulty of the course and the required speed which the horse and rider are challenged to average over the course. At all levels penalty points are assessed for finishing slower than the optimal time. At novice levels penalty points may also be assessed for finishing the course too quickly as higher speed can present a dangerous condition for the horse and rider.

The present embodiments of a speed and distance measurement device are advantageous over the prior art because of the increased accuracy of the device compared to the known speed and distance measuring devices even where GPS signals are not received. Speed is a critical safety factor in such eventing and cross-country competitions. It is difficult for a rider to judge their own speed throughout, and at any given point in time, during an event. Where a rider is aware of their accurate position and speed, the rider is more easily able to consistently determine a safe and competitive speed at which to negotiate the course. In this way where the rider has a better idea of their speed and the distance covered, or left to be covered, the safety as well as the competitiveness of the horse and rider is improved.

A speed and measurement device worn by the rider that measures speed and distance is a novel solution to the problems discussed above. At any and all times during the cross-country course the rider would be aware of the necessity to speed up, or slow down so as to complete the competition as close as possible to the optimum time. Particularly advantageous is the aspect of the present invention where, as the rider comes closer to the finish line the rider can fine-tune the speed to attain the optimal time. Another aspect of the present invention is the ability of the speed and distance measurement device to show the horse and riders' deviation from the desired speed. This would be important for a competitor, either in training or in an event to attain a feel for various speeds. This would help the rider with other equestrian events as well such as racing, endurance riding, etc.

The present invention also relates to a speed and distance measuring device for an athlete in an athletic event in competition and/or training, the speed and distance measuring device having a data storage means, a user input for saving at least one event-based parameter in the data storage means, at least one accelerometer for determining a first speed and distance estimate for the athlete during the competitive or training event, a global positioning system for determining a second speed and distance estimate, and wherein a combination of the first and second speed and distance estimates determines a real-time speed and distance measurement of the athlete for comparison with the event-based parameter.

The present invention further relates to a method of measuring the speed and distance of an athlete in an athletic event, the method comprising the steps of providing a data storage means containing predetermined data relating to the athletes dynamic motion in a plurality of predefined physical states, inputting prior to a start of the athletic event a first event-based parameter to be saved in the data storage means, determining a first nominal speed and distance measurement for the athlete during the athletic event by a first speed and distance measurement device, determining a second speed and distance measurement according to a second speed and distance measurement device, and a combination of the first and second speed and distance measurements determines a real-time speed and distance of the athlete for comparison with the event-based parameter.

### BRIEF DESCRIPTION OF THE DRAWINGS

In the detailed description of the preferred embodiments presented below, reference is made to the accompanying drawings, in which:

FIG. 1 is a diagrammatic representation of the apparatus of an illustrative embodiment of the present invention;

FIG. 2 is a functional block diagram of the software applications in an illustrative embodiment of the present invention;

FIG. 3 is a functional block diagram of the plurality of states in which the software applications function;

FIG. 4 is a flow chart of the data collection and classification function;

FIG. 5 is a flow chart of the calibrated gait component;

FIG. 6 is a flowchart of the measuring state of the device once an event has begun; and

FIG. 7 is a diagrammatic representation of the measuring state and the combinations and interrelationships between the various system components in the measuring state.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways. In the following description, at least one embodiment of the present invention will be described as a software program. Those skilled in the art will readily recognize that the equivalent of such software may also be constructed in hardware. Because data manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the data signals involved therewith, not specifically shown or described herein may be selected from such systems, algorithms, components, and elements known in the art.

The computer software program may be stored in any computer readable storage medium, which may comprise, for example, magnetic storage media such as a magnetic disk (such as a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program that is structurally and functionally compatible with the embodiments of the present invention described below.

It is to be appreciated that the present embodiment is directed towards equestrian events including a horse H and rider R, which is referred to throughout the description in the singular as an athlete, or a user. An important aspect of the present invention is that the speed and distance measurement device is worn by the rider R, and not the horse H, but yet certain physical and dynamic measured parameters of the horse H are used to ascertain the desired metrics which support the algorithms and system. It is also conceivable that aspects of the present invention could be used in sports or activities by athletes and users outside of equestrian events as well.

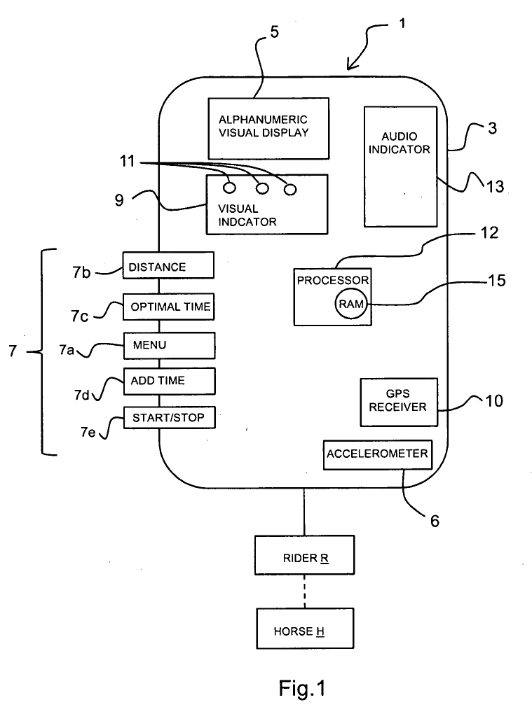

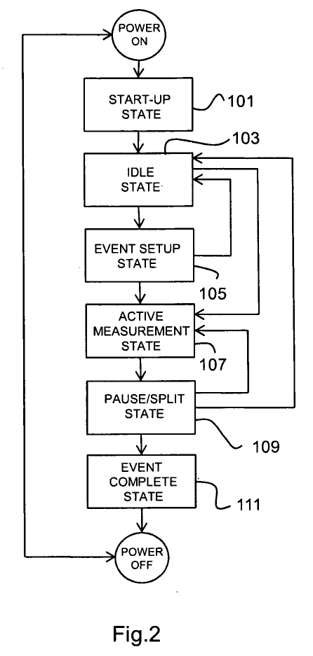

A general description of the method and function of the present invention is shown in the accompanying diagrammatic structural and method implementations shown in FIGS. 1 and 2. The speed and distance measurement device 1 as described herein could be worn by a rider or athlete in much the same manner as a conventional watch or altimeter is carried on a user's wrist. The measurement device 1 itself is provided in general with a housing 3 including a visual digital alphanumeric display 5 for displaying desired modes and states of the device and for displaying input parameters, predetermined stored data as well as the determined and measured metrics and desired output of the device according to the input parameters, predetermined data and other measured and received data.

A plurality of input keys or buttons 7 are provided on the measurement device 1 including, but not limited to, menu button(s) 7a for scrolling through a main menu presented to the user, input parameter buttons 7b, 7c for entering the desired units of any predetermined input parameters like optimal time and distance measurement units. Also provided may be further key(s) such as 7d for entering additional time measurement units, predetermined data etc., and a start/stop/split/pause button 7e. The number of buttons 7 is of course variable depending on the functions and features of the speed and distance measurement device 1 and the menu display and function as well. Because of the vigorous nature of the athletic events and activities for which the presently described measurement device 1 is intended the larger and simpler the arrangement of the keys and buttons 7, the easier it will be for the user to operate the device.

An electronic processor, in particular a microprocessor 12, is provided in the measurement device 1 to receive the input parameters as well as other input data for example predetermined gait data, satellite determined position data from the GPS receiver. The microprocessor 12 is tasked with implementing the software system of the present invention according to all or portions of the input data. The software program and data including input data and generated data are generally stored in a random access memory (RAM) and read only memory (ROM) 15 of the microprocessor. It is possible that other or separate removable/permanent memory devices as discussed above may be incorporated and/or used with the measurement device as well, for example hard drives, flash drives etc.

A global positioning system (GPS) receiver 10 is included in the measurement device 1 and provides geographic location, distance and speed information for the measurement device 1 according to signals received from an array of orbiting satellites. The GPS receiver 10 receives the signals via an antenna from a plurality of satellites and is coupled with the processor 12 and the memory 15 to store position information including a distance between two positions. An accelerometer 6 is used by the measurement device 1 for sensing the harmonic motion of the athlete, more specifically in this case the horse H in the case of a horse H and rider R, and provides acceleration data over time to the microprocessor 12 so that a gait and speed of the athlete and/or animal can be determined.

Also provided on the measurement device is a second visual display or indicator 9 which is not an alphanumeric display and therefore does not display actual numerals or letters. This visual indicator 9 provides an easy to read display of the user's actual condition, distance, speed or position relative to the initially entered parameters for a desired condition or position. This is a critical aspect of the present invention where the physical activity involved in the equestrian event makes it almost impossible to read an alphanumeric display, the indicator 9 imparts a visual representation of the data for an immediate cognizable status of the activity. In the embodiment of FIG. 1 this second visual display 9 includes a series of light-emitting diodes (LEDs) 11, each LED 11 being a different color to indicate the user's current measured distance and/or speed as it relates within a predetermined range to the desired position, distance and/or speed. For example the LED's 11 may be different colors to indicate being within an acceptable range of the desired position, distance and/or speed (green LED), being ahead of (yellow LED) or behind (red LED) a desired position distance and/or speed. The visual indicators 9 may of course be other easy to read and discern indicia or icons so that an athlete involved in the event can quickly ascertain their current relationship to a desired optimal position, location, speed or time.

An audible indicator 13 may alternatively or associatively be used to convey the same relative position, location and speed information to the user by a predefined series of audible sounds, beeps or other readily ascertainable audio indications. Again such audible signals would reveal the same or similar relative position, distance and/or speed of the user as compared to an optimal or desired position, distance and/or speed. These secondary audio and visual displays 9, 13 are an important feature of the present invention since they assist the rider in determining their relative position, distance and/or speed compared to the optimal position, distance and/or speed required for the course and in making decisions during an athletic event without having to specifically read the alphanumeric display 5 to ascertain the appropriate critical information.

Turning to the block diagram and flow chart of FIG. 2, the speed and distance measuring device 1 and systems of the present invention includes several high level states 101-111 and transitions between these states to produce the desired output either in alphanumeric form in the first display 5, and/or in the secondary visual and audible indicators 9 and 13 described above. A startup state 101 is provided when the power to the measurement device 1 is turned on and the GPS signal is established. The system begins with a system check to ensure that the software and hardware is operational. Successful completion of the check in the startup state 101 enables the measuring device 1 to automatically transition to an idle state 103 where any number of desired functions and outputs can be accommodated including for example display of the current date and time, battery power, strength and/or accessibility of a GPS signal etc. In this idle state 103 the remaining measurement components of the measurement device 1 and system may be placed in a low power condition to conserve battery power.

An event setup state 105 is begun upon an indication from the user that certain parameters or other predetermined data is to be entered. This occurs for example by the user actuating one of the Menu button(s) 7a, distance button 7b or optimal time button 7c which would initiate the transition from the idle state 103 to the event setup state 105. In this event setup state 105 the processor 12 is configured to receive and store a number of user event based parameter inputs 121 prior to the competition or training event through certain input keys or buttons 7 on the measuring device 1. These inputs can be any number of parameters but in general include at least an optimal speed Vₒ and/or time to as well as the distance D of the course. Depending upon what information is input, in the event setup state 105 the microprocessor 12 carries out an initial calculation from these inputs to determine a desired or optimal course time and/or speed based on the input parameters. For example given the optimal speed to complete the course, and the distance of the course an optimal time tₒ can be simply determined by dividing the distance D by the speed Vₒ. The use of this optimal event parameter data will be described in further detail below relative to the estimated (real-time) speed and distance data which occurs in the active/measurement state.

After the event setup state 105, and usually just before the event has begun, the user can then place the device into an active/measurement state 107 in which a real-time measurement of the activities of the athlete are determined, received and measured by the device 1. This real-time speed and distance measurements of the athlete can be determined and compared to the optimal course parameter data. Finally, a pause/split/state 109 or a complete state 111 can be attained when the athlete completes the course or pauses along the course for any reason. At this point metrics about the event so far are available to be displayed in a split phase where the device continues to measure the necessary input data for estimated time and distance, while in a pause state the entire measurement input and output determination is suspended. The complete phase is entered into upon completion of the event or competition and any or all of the received and output data may be saved to an appropriate cache or drive for recall and review at a later time.

It is to be appreciated that the measurement device may also have an Off state in which all but the necessary functions for maintaining the memory and other vital continuing functions of the measurement device are shut down to conserve battery power.

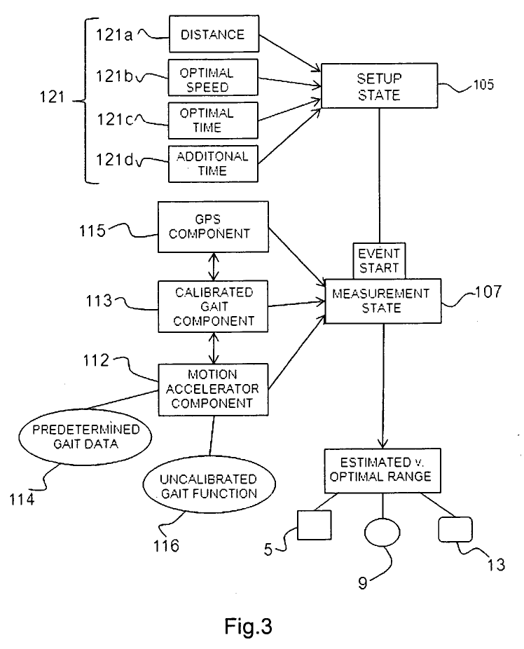

In the event setup state 105 shown in FIG. 3 the user enters a number of predetermined event based parameters 121 for example at least the distance, or course length 121a and the optimal course speed 121b or time 121c for instance via a “scroll-down” type main menu shown to the user by a visual display 5 on the measuring device 1. These parameters are stored by the processor 12 in an appropriate register or cache from the user operated buttons 7 and of course would be available for recall for modification and/or visual observation via the visual display 5 and buttons 7.

A feature of the present invention is the ability to enter a user defined additional time parameter 121d to facilitate the transition from the setup state 105 to the measurement state 107 at the appropriate time, i.e. when the rider crosses the start line. For example the additional time parameter 121d might be 10 seconds so that the athlete may initiate the transition to the measurement state 107 prior to having crossed the start line so that when the race or competition begins the rider does not have to actually to physically correspondingly start their event timer at the same time as the start of the race. The display 5 in this case would show the optimal time plus the additional time so that for example the rider would press start with the additional time and then as the additional time runs down, cross the start line and begin to traverse the competition course. Again the secondary visual and audible indicators 9 and 13 could also be used to indicate the transition to the measurement state 107 and a start of the optimal event time tₒ as well.

Also in FIG. 3 is the functional block diagram of the measurement state 107 which, once the event has begun, determines the estimated distance and speed, i.e. the real time distance and speed of the athlete according to several different components. It is critical to have an accurate assessment of the athlete's real time distance and speed for comparison purposes with the optimal distance and speed as predetermined in the setup state 105 by the initial input parameter data for the event. This is because the accuracy of the output of the measuring device indicating the relative position and speed of the athlete is based on the accuracy of the underlying measurement components determining the athlete's real-time distance and speed.

In the present invention the accuracy of the measurement device 1 is critically based on the ability of the device 1 to cooperatively use several different measurement components in the measurement state 107 and various combinations of these components to improve the accuracy. As shown in FIG. 3 these components include a motion component 112, a calibrated gait component 113 and a GPS component 115. By way of general explanation the motion component 112 provides a primary baseline speed and distance based on the accrued accelerometer data and empirical predetermined gait data 114 for the athlete, all of which is described in further detail below. Assuming that a location measurement device such as a GPS is available to the measurement device 1, the calibrated gait component 113 is updated based on real-time location measurements from the GPS component and the predetermined generic gait data 114 of the motion component. This updated calibrated gait component 113 provides a more accurate assessment of the gait, i.e. walk, trot, cantor, gallop, etc. for that particular horse/rider combination. Besides its usefulness in calibrating the gait data, the GPS component 115 when available can be used to determine the distance, speed and location of the athlete directly although, even the GPS has inherent measurement errors. Each of these components alone can determine an estimate of the athlete's real time distance traveled (position) and speed, however it is the various combinations of these components, and the updating of the predetermined gait data which provides the best estimate and reduction of error for determining the athlete's real time position and speed for comparison purposes with the optimal position and speed. A detail discussion of each of the noted measurement components 112, 113 and 115 as well as the combination of these components follows below.

The individual components 112, 113 and 115 of the measurement state 107 for measuring the athlete's real-time speed and distance covered include initially the motion component 112 where data signals from the accelerometer 6 or a series of accelerometers are used to determine the athlete's distance and speed. This motion component relies essentially exclusively on the data collected by the accelerometers as well as predetermined gait data 114 for use with an un-calibrated gait function 116 of the motion component. The predetermined gait data 114 and un-calibrated gait function 116 are an important part of the present invention where the athlete consists of a horse H and rider R which, although they complete the event together and in most every respect simultaneously, the horse H and rider R have a special relationship because they are of course separate entities each subject to their own, as well as each other's dynamic motion.

In the contemplated embodiment it is important to note that the rider R is usually wearing the measurement device 1 including the accelerometers 6 and which thus receive the horses H dynamic motions indirectly. It is thus important that the un-calibrated gait function initially relies on empirical predetermined gait data 114 derived across a range of motion of different horse/rider subjects. This predetermined gait data 114 is stored in the processor 12 for use in the motion component to gain an initial theoretical indication of the gait, and therefore the speed as described below of the athlete, i.e. rider R and horse H.

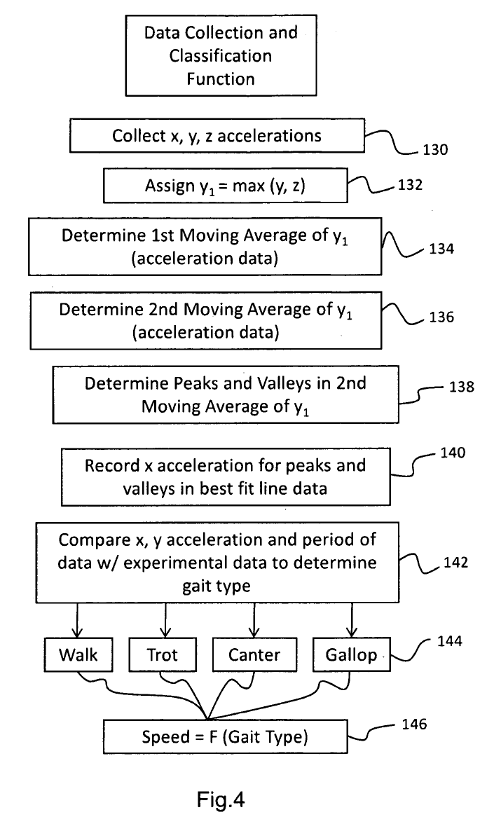

Turning to FIG. 4, the motion component 112 includes a data collection and classification function which obtains data from at least one and more preferably three dimensional accelerometers 6 in the measuring device 1. An accelerometer 6 senses the harmonic motions of the athlete, in the case of a horse H the gait of the horse from walking, trotting, cantering or galloping. The accelerometer(s) 6 are used to provide 2 and/or 3-dimensional acceleration data from the motion of the athlete to a motion algorithm in the microprocessor 12 of the measuring device 1 shown in FIG. 4. The motion algorithm estimates speed and/or distance based on dynamic movements of the athlete in an x-y-z plane. At a frequency for example of 100 Hz the motion component collects at step 130 data points for x, y, and z accelerations of the athlete along the respective axis where x is nominally along the direction of travel, y is nominally vertical and z is nominally horizontal.

It is to be appreciated that the athlete wearing the measuring device is of course moving differently with respect to the horse and that the x-y-z axis of the measurement device 1 and the incorporated accelerometers may not always be aligned in the exact nominal directions of travel. While generally the x data will relatively accurately indicate the forward direction or vector of travel of the athlete, the y and z data may be subject to the rider's arm and wrist movement relative to the horse's dynamic movements. During an athletic event including a horse and rider, a rider tends to rotate their arms and wrists, where the measurement device 1 would generally be supported, about the x-axis so that the vertical axis y and horizontal axis z measurements may to some extent overlap in that the rotation of the arms and wrists can rotate the y and z axis in a plane normal to the forward direction of travel axis x.

To account for this discrepancy and essentially remove the rider's dynamic motion from adversely impacting the necessary data, a data point y₁ is set as the maximum value of vectors y and z taken at step 132. This is because the rider in the case of equestrian events may rotate their wrist so that y becomes more horizontal and z becomes more vertical. Assuming that the horizontal component of the accelerations is relatively small or zero, the real acceleration data to be considered is the vertical acceleration data, no matter which axis, y or z, is obtaining this vertical acceleration. In the extreme case the athlete's motion could cause these axes to invert in which case the z-axis is vertical. Although this method of using the maximum value of y, z as data point y₁ does not give an entirely accurate measurement for the acceleration in the vertical direction, what is more important is that the relative magnitude of the acceleration of the athlete be determined along with the period of the vertical acceleration.

In an embodiment of the present invention using the motion component 112, a 20-point moving average of x and y₁ is initially obtained at step 134. Next, another moving average of the resulting data is taken, this time using a 15-point moving average at step 136. This double moving average has been shown through experimentation to give very good smoothing of the data without sacrificing the important peaks and valleys in the data relating to determination of the magnitude and period of the acceleration. When the acquired data from these averages at steps 134, 136 is observed in the form of acceleration values over time in a best fit curve to the data at step 138, what is obtained is a relatively smooth sinusoidal curve representing the magnitude and frequency of the athlete's harmonic motion over time.

Still considering the motion component 112, next is determined the peaks and valleys in the y₁ data ignoring local minimums and maximums and recording the x acceleration for the peaks and valleys in the y₁ data at step 140 to obtain the acceleration range in x and y₁. The period ts for rise and fall are now known at step 140 from the y₁ acceleration data. Understanding that predetermined gait data 114 for different gait types K has been stored in the measurement device 1 an uncalibrated gait type 116 can be determined based on the acceleration and period data at step 142. It is to be understood that the predetermined gait type data may be known from prior determination of a particular horse, or may be a general determination taken from a range of horses. For the present embodiment it is more likely that the predetermined gait type data is based on a range of horses previously acquired since in many equestrian events it is quite common that a rider will ride different horses.

Acceleration range in the x and y₁ direction along with the period ts of the stride are combined to compare with the predetermined gait type data and so determine the gait type K at step 144. In general, higher acceleration ranges and higher frequencies of stride are indicators of more dynamic gait types K. The considered gait types K in order of increasing dynamics are as follows: walk, trot, canter and gallop. Of course, other horse gait types such as lope, jog, pace, etc. could also have been used.

In one embodiment of the present invention, and now knowing the x and y₁ accelerations, along with the period ts of the stride of the horse obtained as explained above, the gait type K is determined using the formula K=(3x+y₁)/ts. The gait type K is then compared to a look up data table based on the predetermined gait type data and the gait of the horse as a gallop, cantor, trot, walk etc. is determined based on a range of predetermined gait type values.

This aspect of the above discussed algorithm is specifically tailored to equestrian events. For example in the case of a horse refusing to jump an obstacle, a stop can be detected by the accelerometers as an abrupt deceleration. After a stop, the rider generally circles back to attempt the jump again. The reverse distance in such circumstances covered by this circling can be ignored in most cases and not counted in the total distance covered estimation.

With a theoretical gait type K determined as discussed above according to the predetermined gait type data, speed Vc is estimated using an empirically-derived formula relating speed to gait period ts for the gait type K as shown in step 146. In one embodiment of the present invention this formula is:

Vc=(3.7)/(K*ts)+1.1 (meters per second)

Estimated distance covered can then be calculated by assuming a constant speed V_{c} over the time period of the stride ts.

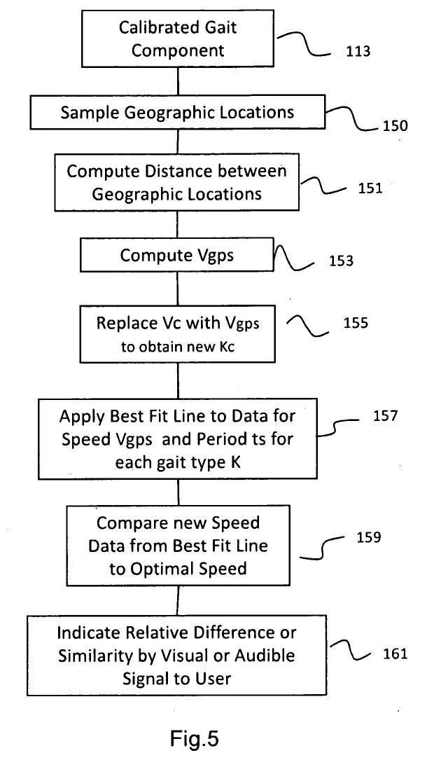

The next important component of the measurement state 107 is the use of the GPS data to provide an additional speed/distance measurement and to determine the calibrated gait component 113 seen in FIG. 5. A location determination algorithm hereinafter referred to as the GPS algorithm determines a velocity V_{gps} according to a sampling of separate geographic locations at step 150 for instance via longitude, latitude and altitude data over time. Computing the distance traveled between these separate geographic locations at step 151, and applying the known sampling time between which the locations were sampled, a real-time velocity V_{gps} 153 can be obtained via the GPS algorithm.

With a measured real time velocity V_{gps} 153 and the stride period ts determined by the accelerometers in the motion component 112 the stride period ts is now related to an actual measured speed so that the calibrated gait Kc is thus always being updated and classified using the GPS data as long as the GPS data is available. With respect to this embodiment of the present invention, speed V_{gps} is determined by the GPS data while the period of the stride ts is measured by the accelerometers. Several points are taken for each gait type encountered. A best-fit line relating period to speed is calculated for each gait type at step 157. The new speed data from the best fit line can be compared to the optimal speed at step 159 and the relative difference can be presented either visually or audibly to the user at step 161. In the case of a lost GPS signal, if the best-fit line for the current gait is available then the period ts is used to calculate speed based on the latest best-fit line which has been updated and refined up until this point by the GPS algorithm. This is referred to as “calibrated gait” in the Figures.

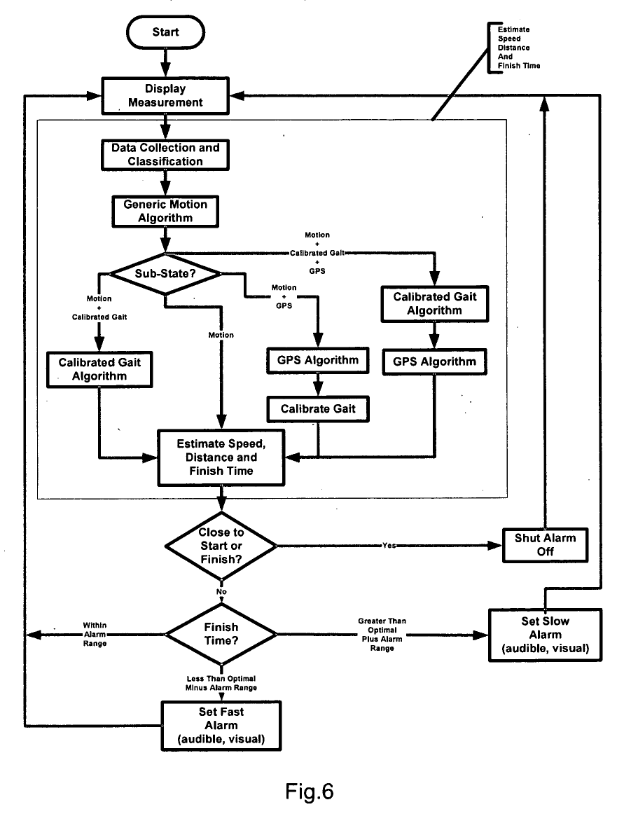

Turning to the flow chart in FIG. 6 with respect to the above discussed states and components of the measurement device, also referred to in the figure as a sub-state, it is an important aspect of the present invention that the above described components can be used together or separately to obtain an accurate speed and distance measurement. In the motion component measurement state 107 discussed above the system is capable of determining the speed and distance solely from the accelerometer data of the motion component 112 and the predetermined gait data 114 as seen in the flow path labeled “motion”. As discussed above the data being used in the speed estimation Vc during the motion component sub-state is generic data taken across a number of horses, and it is not tuned or calibrated to the current athlete. This is the initial state of the measurement state 107 and it is entered at the moment the ride begins and the measurement state 107 is initiated. At this point, there is no data about the specific horse/rider currently using the device. Data could have been saved from the last ride but, in many competitions, the same rider R may ride multiple horses so there is no guarantee that the same horse/rider combination is using the device again, so the empirical data available in the initial state is an initial un-calibrated point for the speed and measurement device 1 at the initiation of the measurement state 107.

It is generally assumed that at the start of an athletic event the GPS receiver is capable of beginning to receive and accumulate location data as well, so the GPS algorithm discussed above is also beginning to calibrate the gait of the specific athlete. It is to be appreciated that the system is accumulating GPS data and so is usually at any given point in time in the “motion+GPS”, and/or in the “motion+calibrated gait+GPS” flow path shown in FIG. 6, until or unless the GPS signal is lost for some reason. Where the GPS was initially calibrating the gait in these flow paths, and then becomes unavailable, as is shown in the flow path of FIG. 6 as “motion+calibrated gait”, the best fit lines from the previously collected GPS data are still available to the device 1 for each gait type Kc and although at least at this point no longer being updated, the current speed and distance covered by the athlete may be determined from these best fit lines.

As previously discussed, for the “motion+GPS” flow path the GPS delivers a location estimate at a 5 Hz frequency for example. As the horse H takes strides, successive GPS locations are recorded. The GPS locations are converted to a speed V_{gps} based on the distance traveled over time. Note that the GPS also has the capability to supply a calculated speed directly and this can be used as an alternative to calculating GPS speed based on successive positions. The “motion” measurement is the same as previously described.

In another sub-state, or embodiment, the measurement device uses all three methods to estimate speed and distance—“motion”, “GPS” and “calibrated gait”. Estimated distance covered is then calculated by assuming the speed is constant over the time period of the stride.

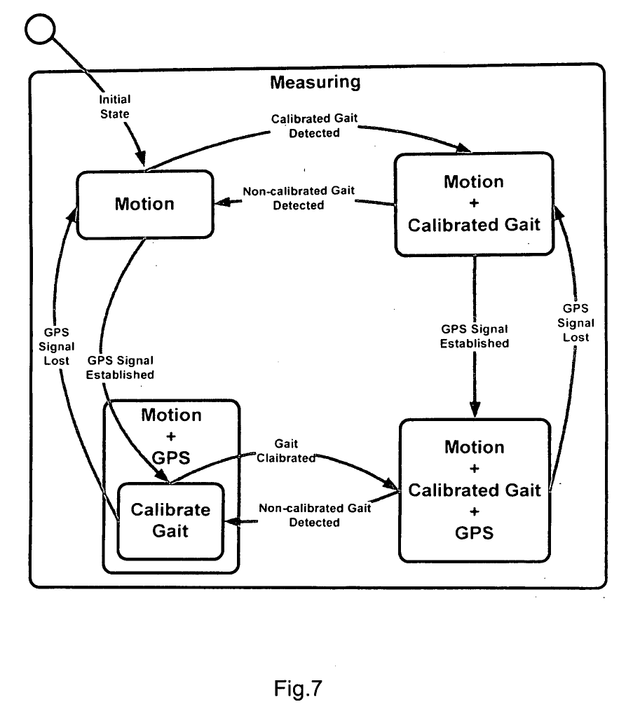

The GPS data and calibrated gait algorithm are thus used in each of the flow paths shown in FIG. 7 with the exception of the “Motion” flow path. In this way the motion data may be used alone and/or in combination with the other components to provide further estimation accuracy of the measuring device. In the flow path “motion+calibrated gait+GPS” in FIG. 5, the GPS component data can be used to directly measure speed and distance covered by the athlete. The data from all available components is combined to get a best estimate. In this aspect of the present invention all three measurement methods are used to measure/estimate speed and distance covered. The generic motion algorithm as updated and refined by the calibrated gait algorithm along with the direct GPS measurement of speed and distance are used to provide a highly accurate estimation of the athlete's real time distance and speed. In the embodiment of the present invention shown in the flow path “motion+calibrated gait+GPS” in FIG. 5 the three discussed components of the measurement state for estimating speed and distance covered, i.e. the generic motion component, calibrated gait component and GPS component, each have inherent errors in their measurements. A Kalman Filter may be used to combine the available estimates of speed/distance into a single best estimate. The combination of two or three rough estimates from these components can be more accurate than any one individually by employing a Kalman Filter.

The GPS system is used to estimate speed and/or distance covered by the athlete from the start line of the racecourse, and the global positioning system and the accelerometer system work in conjunction so that the speed and distance of the rider can be most accurately estimated even in cases where GPS data for example cannot be obtained by the speed and measurement device. There are many times that the athlete will be within GPS range during the event, however the GPS signal can be intermittent based on being on trails in woods or affected by other obstacles such as mountains or hills. The GPS signal can also be affected by movement and position of the GPS antenna located in the device attached to the athlete.

As discussed above with respect to the calibrated gait, while there is a GPS signal, the GPS delivers a location estimate at a 5 Hz frequency. As the horse takes strides for a given gait, successive GPS locations are recorded and the distance covered and speed are directly obtained from this GPS data. The GPS locations are converted to a speed based on the distance traveled over time. Note that the GPS also has the capability to supply a calculated speed and this can be used as an alternative to calculating GPS speed based on successive positions.

When the GPS signal is lost the system uses the Generic Motion Algorithm and, if available, the Calibrated Gait Algorithm to estimate distance. If and when the GPS signal is restored the system cannot blindly use the new location reported by the GPS. The rider could have entered the woods at one point, traveled a significant distance and then exited the woods not far from the entrance. In this case the GPS position needs to be compared to the distance estimated by the alternative methods. If they are close then the GPS position should be used as it will be the most accurate. If they are not close then the current estimate is used and the GPS can be used for successive measurements from the current position.

It is expected that the GPS signal will be the most accurate especially in taking successive quick data points. It may turn out that, if the GPS signal is present, then that it is used solely for speed calculation during this time. Next best estimate is the Calibrated Gait Algorithm which would be used if available but no GPS signal is available. And, the Generic Motion algorithm would be used as a last resort. This could be used as an alternative to the combination of the measurements using a Kalman Filter or other method.

It is to be appreciated that for longer rides (e.g. 4 hours), to save on battery life, GPS data can be taken as infrequently as one data point per minute. The GPS module is put in a low power, trickle mode during most of the ride in this case. Also, in the case of a horse refusing to jump an obstacle (a stop) is also detected by the GPS. After a stop, the rider generally circles back to attempt the jump again. The distance covered by this circling is ignored and not counted in the total distance covered estimation.

There is an important structural display aspect of the present invention so that the critical data described above can be effectively communicated to the rider or athlete during an event. Because of the difficulty in viewing numerals and letters on a conventional alphanumeric display during an athletic event the measurement device contemplates the use of additional visual and audio indicators 9 and 13 for example colored LEDs 11 which indicate for example whether the estimated, or real-time speed and distance as determined in the above discussed measurement state 107 is within an acceptable or predefined range as compared to the optimal speed. If the measured real-time speed is outside of a desired predetermined range, e.g. the athletes speed is too slow or even too fast by the LED's could indicate this as well by using different colors to alert the athlete. By way of example an activated green LED on the face of the measurement device would indicate that the athlete's pace is within the acceptable range to complete the course in at the optimal time. An activated red LED would indicate that the athlete's speed is too slow to meet the optimal time, and a yellow LED could indicate to the athlete is completing the course at a speed higher than that required to meet the optimal time. These visual indicators provide an effective way for a rider to immediately and with his/her peripheral vision without diverting attention from the activity or event to assess their speed and appropriate completion of the course within the optimal time.

The present invention also contemplates an audible signal from the audio indicator 13 which could similarly effectively indicate the necessity for the athlete to either speed up or slow down to maintain a desired optimal speed. For example a steady consistent audible beep would indicate that the rider is within an acceptable speed to complete the course was in the optimal time. Whereas a different series of several fast beats would indicate that the rider is either behind or ahead of the optimal time and speed for appropriate completion of the event.

The estimation of finish time is straightforward. This is only important if the length of the ride was configured during the event setup state 105. Setting a distance is of course useful for the cross country event and for other competitive trail riding events. For casual trail riding, the length of the ride and the finish time would not have to be configured. To determine the finish time subtract the current measured real time distance covered from the predetermined length of the ride to obtain the distance left. Then divide the distance left by current speed to get an estimate of the time remaining to finish the course or event.

As seen in the flow chart of FIG. 5 as the rider is close to completing the event, e.g. within for example 500 yards of the finish line, the visual and audible signals can be shut off if necessary. While the athlete is still on the course the processor continues to compare the estimated time to the optimal time and inform the rider via the visual and audible displays whether the athlete is within the desired range. When the rider or athlete has completed the course the athlete presses the stop button to indicate the completion of the event time and indicate to the underlying algorithms that the collection of data of time distance and location data is now complete.

The invention has been described in detail with particular reference to certain preferred embodiments thereof, for example a horse and rider but could also be potentially be used with merely a single direct subject wearing or supporting the device e.g. a runner or walker and the same methodology and system used to determine the runners speed and distance based on gait. Similarly, the above described device could be used in with a subject wearing the device in another mode of transport such as a bicycle. It will be understood that variations and modifications can be effected within the spirit and scope of the invention.

I/we claim:

1. A speed and distance measuring device for an athlete in an athletic event in competition and/or training, the speed and distance measuring device comprising:
a data storage means;
a user input for saving at least one event-based parameter in the data storage means;
at least one accelerometer for determining a first speed and distance estimate for the athlete during the competition or training;
a global positioning system for determining a second speed and distance estimate; and
wherein a combination of the first and second speed and distance estimates determines a real-time speed and distance measurement of the athlete for comparison with the event-based parameter.

2. The speed and distance measuring device for an athlete in an athletic event in competition or training as set forth in claim 1 further comprising a first visual indicator comprising an alphanumeric or graphical digital display and a second indicator comprising one of an audible or alternative visual indication of a result of the comparison of the real-time speed and distance measurement with the event-based parameter.

3. The speed and distance measuring device for an athlete in an athletic event in competition or training as set forth in claim 2 wherein acceleration data from the at least one accelerometer is continuously used to provide a calculation of the real-time speed and distance of the athlete, and the speed and distance measuring device includes an interruption state comprising an interruption of data transmission in the global positioning system; and
the interruption state accomplishes the calculation of the real-time speed and distance measurement by calibration of the accelerometer data according to data acquired from the global positioning system for the second speed and distance estimate prior to the interruption of the data transmission in the global positioning system.

4. The speed and distance measuring device for an athlete in an athletic event in competition or training as set forth in claim 1 further comprising:
data from the at least one accelerometer to determine the first speed and distance estimate;
data from the global positioning system to determine the second speed and distance estimate; and
wherein data transmission in the global positioning system is interrupted for a period of time and the combination of the first and second speed and distance estimates occurs with a newly determined first speed and distance estimate and a previously determined second speed and distance measurement to determine the real-time speed and distance measurement of the athlete for comparison with the event-based parameter.

5. The speed and distance measuring device for an athlete in an athletic event in competition or training as set forth in claim 3 further comprising a plurality of predetermined gait data for the athlete stored in the data storage means to facilitate calculation of the first speed and distance estimate and wherein the second speed and distance estimate is combined with the first speed and distance estimate to obtain a calibrated gait and determine the real-time speed and distance of the athlete for comparison with the event-based parameter.

6. A speed and distance measuring device for an athlete in an athletic event, the speed and distance measuring device comprising:
one or more accelerometers for determining a first speed and distance estimate for the athlete during the competitive or training event;
a location measurement device for determining a second speed and distance estimate; and
wherein a combination of the first and second speed and distance estimates determines a real-time speed and distance of the athlete.

7. The speed and distance measuring device for an athlete in an athletic event as set forth in claim 6 wherein in a loss of new data from the location measurement device the one or more accelerometers continuously updates the real-time speed and distance of the athlete without any corresponding new data from the second location measurement device; and
a calculation of the real-time speed and distance measurement is based on calibration of the accelerometer data according to a last determined second speed and distance estimate.

8. The speed and distance measuring device for an athlete in an athletic event in competition or training as set forth in claim 7 further comprising a state wherein the first speed and distance estimate is determined according to one of a plurality of predetermined gait data of the athlete stored in the speed and distance measuring device.

9. The speed and distance measuring device for an athlete in an athletic event in competition or training as set forth in claim 6 wherein the location measurement device is a global positioning system (GPS) compromised by:
an interruption of data transmission for the second speed and distance estimate and including the further step of estimating the real-time speed and distance of the athlete for comparison with an event-based parameter using a previously obtained second speed and distance estimate in combination with the first speed and distance measurements; and
wherein the real-time speed and distance of the athlete is recalculated according to both the first and second speed and distance estimates once the data transmission for the second speed and distance estimate is reestablished.

10. The speed and distance measuring device for an athlete in an athletic event in competition or training as set forth in claim 8 further comprising acceleration data obtained from a first, second and third accelerometer for determining a first speed and distance estimate for the athlete during the competitive or training event; and
wherein the first accelerometer obtains data representing a forward acceleration value in a forward direction of travel of the athlete, and a maximum value of the second and third accelerometers is obtained to represent a vertical acceleration value in a vertical direction and a relative magnitude of the forward and vertical accelerations of the athlete is determined relative to time to determine a frequency of a measured gait in comparison to the predetermined gait data.

11. A method of measuring the speed and distance of an athlete in an athletic event, the method comprising the steps of:
providing a data storage means for storing data relating to the athletes dynamic motion in a plurality of predefined physical states;
inputting prior to a start of the athletic event a first event-based parameter to be saved in the data storage means;
determining a first nominal speed and distance measurement for the athlete during the athletic event by a first speed and distance measurement device;
determining a second speed and distance measurement according to a second speed and distance measurement device; and
wherein a combination of the first and second speed and distance measurements determines a real-time speed and distance of the athlete for comparison with the event-based parameter and a result of the comparison is output to the athlete via at least one of a visual and audible display.

12. The method of measuring the speed and distance of an athlete in an athletic event as set forth in claim 11 wherein the first nominal speed and distance measurement further comprises the steps of measuring a first acceleration component of the athlete in a substantially horizontal direction by an accelerometer.

13. The method of measuring the speed and distance of an athlete in an athletic event as set forth in claim 12 wherein the first nominal speed and distance measurement further comprises the step of determining a nominal vertical acceleration based on a second and third acceleration components of the athlete in a respective second and third directions and ascertaining a relative magnitude and period of the athlete's harmonic motion over time.

14. The method of measuring the speed and distance of an athlete in an athletic event as set forth in claim 13 wherein the first nominal speed and distance measurement further comprises the step of ascertaining one of the plurality of predefined physical states of the athlete according to a comparison of the relative magnitude and period of the athlete's harmonic motion with predetermined data relating to the athletes dynamic motion in the plurality of predefined physical states.

15. The method of measuring the speed and distance of an athlete in an athletic event as set forth in claim 11 wherein the first nominal speed and distance measurement further comprises the step of estimating the nominal speed of the athlete according to a predetermined relationship between the period and the ascertained predefined physical state of the athlete.

16. The method of measuring the speed and distance of an athlete in an athletic event as set forth in claim 11 further comprising the step of determining any change in the plurality of predefined physical states with data derived from the second speed and distance measurement from the second speed and distance measurement device.

17. The method of measuring the speed and distance of an athlete in an athletic event as set forth in claim 16 wherein the second speed and distance measurement further comprises the step of determining a new measured speed and replacing the nominal speed with the new measured speed to determine the change in the predefined physical state of the athlete.

18. The method of measuring the speed and distance of an athlete in an athletic event as set forth in claim 11 further comprising the step of indicating by one of visual and audible signal to the athlete a relative difference or similarity in at least one of the first and second speed and distance measurements as compared to the event-based parameter.

19. The method of measuring the speed and distance of an athlete in an athletic event as set forth in claim 18 further comprising the step of displaying in a non-alphanumeric display the visual signal to the athlete a relative difference or similarity in at least one of the first and second speed and distance measurements as compared to the event-based parameter.

20. The method of measuring the speed and distance of an athlete in an athletic event as set forth in claim 11 wherein the second speed and distance measurement device is a global positioning system (GPS) compromised by:
an interruption of data transmission for the second speed and distance measurement and including the further step of estimating the real-time speed and distance of the athlete for comparison with the event-based parameter using a previously obtained second speed and distance measurement in combination with the first speed and distance measurements; and
recalculating the real-time speed and distance of the athlete according to both the first and second speed and distance measurements once the data transmission for the second speed and distance measurement is reestablished.
